(19) United States
(12) Patent Application Publication
(10) Pub. No.: US 2008/0236106 A1
(43) Pub. Date: Oct. 2, 2008

(54) Capsule Filling Machine and Method For Producing Sealed Capsules

(76) Inventors: Roberto Trebbi, Castenaso( Bologna) (IT); Caterina Funaro, Bologna (IT)

Correspondence Address: ARENT FOX LLP, 1050 CONNECTICUT AVENUE, N.W., SUITE 400, WASHINGTON, DC, 20036, US

(21) Appl. No.: 10/586,874

(22) PCT Filed: Feb. 23, 2005
(86) PCT No.: PCT/IB05/00479

§ 371 Date: Jul. 21, 2006

(30) Foreign Application Priority Data
Feb. 27, 2004 (IT) BO2004A000117

(51) Int. Cl. A61J 3/07

(52) U.S. Cl. 53/471; 53/281

(57) ABSTRACT

A capsule filling machine (4) for the production of hard gelatin capsules (C) of the type with lid (2) and body (1) containing pharmaceutical material, the machine (4) being of the type comprising a station (5) for feeding the capsule bodies (1) and lids (2); a dosing station (6) for filling a dose of the material into each capsule body (1); and a station (7) for closing the capsules (C) by placing each lid (2) over the respective body (1) so that their respective annular ends (2a, 1a) overlap. Between the dosing station (6) and the closing station (7) there is at least one intermediate operating station (8) for applying a sealing substance to the capsule lid and bodies in the vicinity of their ends (1a, 2a).

### TECHNICAL FIELD

The present invention relates to a capsule filling machine and method for producing sealed capsules.

In particular, the present invention can be advantageously applied to the production of hard gelatin capsules of the type with lid and body which contain pharmaceutical material in powder or solid form, such as tablets, microtablets, pellets and the like, or in liquid form, and which the present specification expressly refers to but without restricting the scope of the invention.

### BACKGROUND ART

The operation of a modern capsule filling machine basically consists of a sequence of steps comprising the following main steps: a step of opening the closed empty capsules at a station where the capsule bodies are separated from the lids to form two separate rows of bodies and lids; a step of filling a dose of pharmaceutical material into each capsule body at a dosing station; and a step of closing the filled capsule by applying a lid to the respective body.

Once closed, the capsules are individually checked at an appropriate inspection and weighing station and, finally fed out of the machine into an appropriate container.

A more and more frequent requirement is for pharmaceutical capsules made in the above manner to also be sealed, which involves another step in their manufacturing process to be applied after the capsules have been closed. Sealing is designed not only to ensure that the pharmaceutical material, especially if liquid, does not leak out through the connection between capsule lid and body but also to prevent the risk of fraudulent tampering with, or undetected adulteration of, the capsules.

At present, there are several different methods of making this seal. These can be divided broadly into two main types.

According to a first type, the entire outside surface of each capsule is provided with a sealing coat, as described, for example, in International patent WO 02/060372.

In this method, a predetermined quantity of capsules made in a capsule filling machine are collected in a rotary drum and then sprayed with a sealing substance such as an organic solvent (for example, an aqueous ethanol solution) to create a sealing coat which is completed by a substantially simultaneous step of drying the coat while the capsules are still inside the drum.

This method, although it provides satisfactory results, has the drawback of necessitating the use of the rotary drum in addition, obviously, to the capsule filling machine in which the capsules themselves are made.

According to a second type, sealing is accomplished by applying the sealing liquid (organic solvent or other equivalent substance) only at the discontinuous outside portion of the capsule defining the joint between the lid and the body once the two parts have been securely fitted to each other.

In a known solution implementing this type of method, each individual capsule is sprayed (or, more generally, coated) with the sealing liquid in a self-contained sealing machine to which the full, closed capsules are fed by the filling machine that has made them.

This second type of method is also embodied in two different constructional solutions described in U.S. Pat. Nos. 4,793,119 and 5,094,184.

In these solutions, the perfectly closed, full capsules are transferred individually on appropriate conveyors from the capsule filling machine to a sealing machine of the type comprising a station for horizontally positioning each single capsule.

According to the above mentioned United States patents, each capsule is moved into contact with a sealing roller, which is partially immersed in a tank containing the sealing substance, and rotated about its longitudinal axis in such a way that the roller applies a “band” of the sealing substance to the joint between the lid and the body. This outside sealing band is then dried at a subsequent drying station.

These methods of externally sealing a restricted area of the capsules, however, have considerable drawbacks.

Thus, in the first of the above mentioned solutions, it is not possible to control the uniformity of sealing substance distribution, which means there is no guarantee of creating an effective seal. The relative position between spray nozzle and capsule makes it necessary to spray an excessive quantity of sealing substance, with the risk of the substance dripping onto parts of the machine and damaging the machine or, at best, requiring frequent maintenance and cleaning.

The second of the solutions described above has the drawback of reducing productivity since the steps of transferring the capsules from the filler and positioning them on the conveyors require time, added to the fact that the passage of the individual capsules over the drums is necessarily slow in order to correctly distribute the sealing substance.

Furthermore, both the solutions described above involve handling the individual capsules already made as they feed out of the capsule filler towards another machine which, besides slowing down production, as already mentioned, creates the added risk of leakage of product from the capsules before they are sealed, especially if the material inside the capsules is liquid.

The aim of the present invention is therefore to overcome the considerable drawbacks of prior art.

More particularly, the main aim of the invention is to create perfectly sealed capsules of the lid and body type by a quick and sure process performed inside the same machine that fills and closes the capsules themselves, thus eliminating the need not only for additional sealing apparatus outside the capsule filler but also for the complex handling apparatus required to feed the capsules to the external sealing apparatus without damaging them.

### DISCLOSURE OF THE INVENTION

The present invention accordingly provides a method for producing sealed capsules, each defined by a body coupled with a lid, the method at least comprising the steps of filling the capsule body with a quantity or dose of material and closing the capsule by placing the lid over the body so that their respective annular ends overlap; the method being characterised in that it further comprises a step of applying a sealing substance to at least one of the overlapped ends of the capsule body and lid, said sealing step being performed before the capsule is closed.

The present invention also relates to a capsule filling machine for the production of hard gelatin capsules of the type with lid and body containing pharmaceutical material, the machine being of the type comprising a station for feeding the capsule bodies and lids; a dosing station for filling a dose of the material into each capsule body; and a station for closing the capsules by placing each lid over the respective body so that their respective annular ends overlap; the machine being characterised in that between the dosing station and the closing station there is at least one intermediate operating station for applying a sealing substance to the capsule lids and bodies in the vicinity of their ends.

### BRIEF DESCRIPTION OF THE DRAWINGS

The technical characteristics of the invention, with reference to the above aims, are clearly described in the claims below and its advantages are apparent from the detailed description which follows, with reference to the accompanying drawings which illustrate a preferred embodiment of the invention provided merely by way of example without restricting the scope of the inventive concept, and in which:

FIG. 1 is a schematic top plan view, with some parts cut away for clarity, of a preferred embodiment of a capsule filling machine according to the invention, for making sealed capsules;

FIG. 2 is a side view, with some parts in cross section and others cut away, of a detail A of the machine of FIG. 1;

FIG. 3 is a side view, with some parts in cross section and others cut away, of another detail B of the machine of FIG. 1;

FIG. 4 is a side view, with some parts in cross section and others cut away, of yet another detail C of the machine of FIG. 1;

FIG. 5 schematically illustrates the sequence of steps constituting the method according to the present invention, implemented by the capsule filling machine of FIG. 1.

### DETAILED DESCRIPTION OF THE PREFERRED EMBODIMENTS OF THE INVENTION

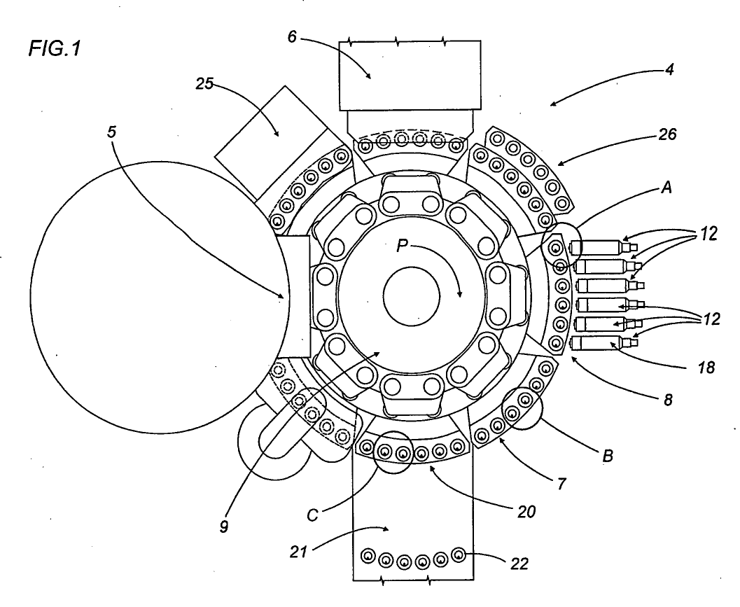

FIG. 5 schematically illustrates the sequence of steps constituting the method according to the present invention for making sealed capsules C of the type with lid 2 and body 1 coupled to each other in such a way that their ends 1a and 2a overlap and containing preferably but not exclusively pharmaceutical material in liquid or powder form, whilst FIGS. 1 to 4 illustrate a capsule filling machine 4 that implements said method.

The method illustrated in FIG. 5 comprises the steps (performed according to the direction K) of filling the body 1 of each capsule C with a dose 3 of pharmaceutical material (arrow F3), applying a sealing substance to at least one of the ends 1a, 2a of the body 1 and lid 2 to be overlapped, and then completing the capsule C by moving the body 1 and the lid 2 together (arrows F100) so that one fits into the other and in such a way as to simultaneously close and seal the capsule C.

The empty capsules C are closed when they are fed into the machine at the start of the process. Before they can be filled, they must be opened by moving the body 1 and the lid 2 apart to separate them (arrows F101).

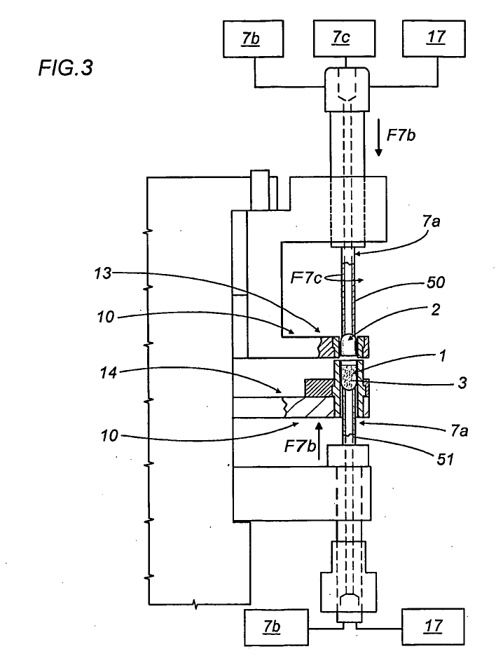

As illustrated in FIG. 5, the step of applying the sealing substance is performed during a step of rotating at least the lid 2 about its longitudinal axis Z in such a way that the sealing substance is applied to the annular end 2a of the inside surface of the lid 2 (FIG. 5—arrow F103, and FIG. 3—arrow F7c).

In other words, the sealing substance is applied while the body 1 and lid 2 are being held apart (that is, when the capsule C is still open) and while at least the lid 2 (preferably) is being rotated about its longitudinal axis Z.

The sealing substance is applied by spraying and consists of a mixture of different substances depending on operating requirements and on the type of capsule C, whose body 1 and lid 2 are usually made from hard gelatin.

The sealing substance normally used is an aqueous mixture of water and ethanol or the like or a cellulose based liquid substance or a liquid substance based on gelatin of the same type as the one which the lid 2 and body 1 are made of.

The step of closing the body 1 and lid 2 is followed by a step of drying the sealing substance while the capsule C is held firmly in the closed position so as to eliminate or minimise the risk of dripping or leakage of the material from the capsule C.

Preferably, the drying step is performed while the sealed capsule C is advanced and/or fed out towards capsule collection stations.

As better illustrated in FIG. 1, a capsule filling machine 4 for making the sealed capsules C described above essentially comprises the same operating units as a customary capsule filling machine for making capsules C, that is to say, a station 5 for feeding the bodies 1 and lids 2, a dosing station 6 for filling the material into the bodies 2, and a station 7 for closing the capsules C by placing the lid 2 of each capsule C over the respective body 1 so that their respective ends 1a, 2a overlap.

The stations 5, 6 and 7 are not described in detail and are only partly illustrated in FIG. 1 since they are of known type.

In particular, the feed station 5 feeds preferably closed, empty capsules C and opens them in a known manner (not illustrated) before they reach the dosing station 6.

The capsule filling machine 4 preferably also comprises a station 25 for detecting the presence of the bodies 1 and lids 2 and a station 26 for selecting reject capsules C, both these stations being of known type and therefore not described in detail.

FIG. 1 also shows that between the dosing station 6 and the closing station 7, there is a station 8 for applying a sealing substance to at least one of the ends 1a, 2a of the body 1 or of the lid 2 or both.

More specifically, the machine 4 comprises a capsule C handling turret 9 that rotates with preferably continuous or alternating motion along a circular path P that enables the capsules C to be fed to the aforementioned feed, dosing and closing stations 5, 6 and 7.

The station B is also located on the circular path P of the turret 9.

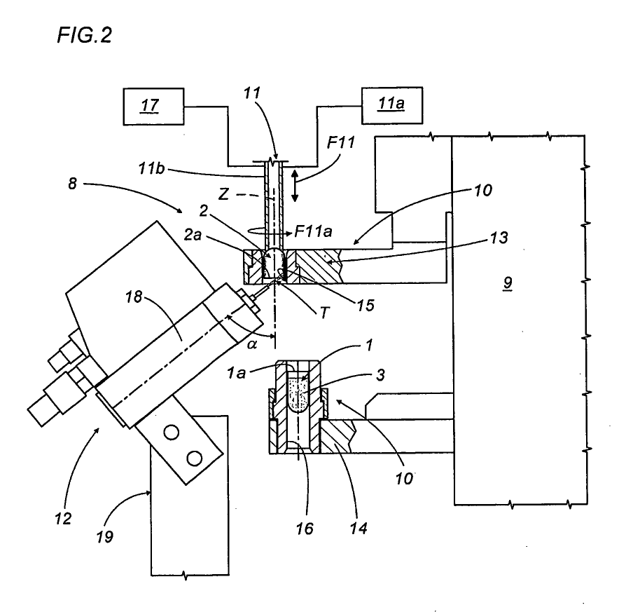

As shown in FIG. 2, the station 8 for applying the sealing substance comprises retaining means 10 for holding the capsule body 1 and the lid 2 separate from each other and positioned radially on the turret 9; means 11 for handling the lid 2 and acting in conjunction with the retaining means 10; and means 12 for applying the sealing substance, facing the retaining means 10 and operating at the lid 2.

More specifically, and still with reference to FIG. 2, the retaining means 10 comprise two separate arms 13 and 14 for each capsule C, which are parallel to each other, protrude radially from the turret 9 and turn as one with the turret 9 itself.

In practice, the arms 13, 14 have respective open-ended bushes 15, 16 forming retaining seats, the top one 15 for holding the lid 2, and the bottom one 16 for holding the body 1 filled with a dose 3 of material.

The handling means 11 are located in the vicinity of the retaining means 10 and comprise a cylindrical pin lib that moves vertically in both directions (arrows F11) and is equipped with means 17 (represented by a block in the drawing) for creating a vacuum which enable it to hold and rotate the lid 2 (using respective means 11a—arrow F11a) while the sealing substance is applied by the sealing means 12 in such a way as to apply the sealing substance uniformly along the circular inside area at the end 2a of the lid 2.

With reference again to FIGS. 1 and 2, the means 12 for applying the sealing substance comprise at least one sealing substance spray nozzle 18 for each lid 2 facing the sealing station 8.

Each nozzle 18 is mounted on a bracket 19 and is inclined by an angle α with respect to the longitudinal axis Z of rotation of the lid 2 in such a way as to direct the spray jet T at the inside surface of the end 2a of the lid 2.

In practice, the nozzle 18 is mounted in such a way as to spray from the bottom up in the direction of the inside surface of the end 2a of the lid 2 without interfering with the rotation of the turret 9 and of the arms 13 and 14 supporting the lid 2 and body 1.

The sealing substance used is preferably an aqueous mixture of water and ethanol or it may be a cellulose based substance or a substance based on the same type of gelatin as the one which the lid 2 and body 1 are made of.

As better illustrated in FIG. 3, the closing station 7 is equipped with second means 7a for handling the lid 2 and body 1 in such a way as to close them by overlapping them at the ends 1a and 2a.

The second handling means 7a comprise a pair of hollow cylindrical pins 50, 51 located on the sides opposite the arms 13, 14 supporting the body 1 and lid 2 and equipped with the vacuum generating means 17 in order to make stable contact with the body 1 and lid 2.

The second means 7a are also equipped with vertical drive means 7b which move the ends 1a and 2a towards each other until they overlap and close (arrows F7b in FIG. 3).

Preferably, at least one of the pins 50, 51 is equipped with means 7c for rotating it about its axis as the lid 2 and body 1 overlap, thus producing a twisting movement as the two parts are joined in such a way as to spread the sealing substance more evenly over the surfaces of the two ends 1a, 2a (arrow F7c).

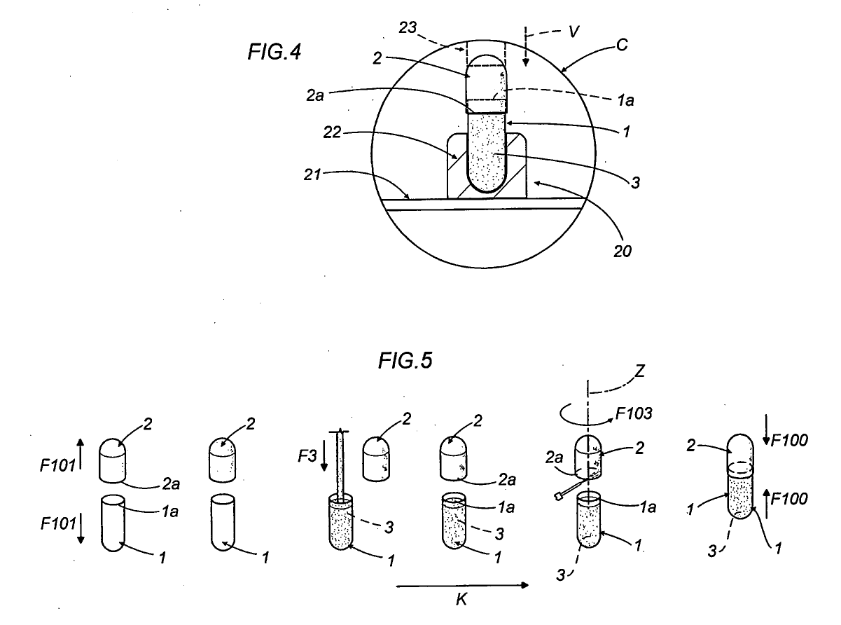

As illustrated in FIGS. 1 and 4, downstream of the closing station 7 on the circular path P of the turret 9, there may be a station 20 for drying and expelling the sealed capsules C thus obtained.

More specifically, the drying station 20 comprises a capsule C conveyor belt 21 positioned in the vicinity of and under the turret 9.

The belt 21 may have a plurality of seats 22 each designed to accommodate a single capsule C which can be transferred by respective handling means 23 from the turret 9 to the seat 22 in a vertical direction V so that the capsule C remains in a stable position until it is expelled.

It will be appreciated that a capsule filling machine made in this way and implementing the method described above achieves the above mentioned aims because it enables the capsules to be sealed in the capsule filling machine itself before they are finally closed.

More specifically, the sealing method according to the invention brings, considerable advantages thanks especially to the speed at which the sealing step is carried out without allowing the material, inside the capsules to leak out, producing perfectly sealed capsules handled in optimum manner before being fed out of the capsule filling machine that implements the method itself.

Furthermore, since the capsules are filled, closed and sealed in the same machine, the space occupied by production is significantly reduced, which enables considerable savings.

In addition, the method according to the invention can be used with different types of sealing substances according to operating requirements depending, for example, on specified regulations or on the type of material used to fill the capsules.

It will be understood that the invention as described herein can be modified and adapted in several ways without thereby departing from the scope of the inventive concept. Moreover, all the technical details may be substituted by equivalent elements.

1. A capsule filling machine (4) for the production of sealed capsules (C) of the type with lid (2) and body (1) containing pharmaceutical material, the machine (4) being of the type comprising a station (5) for feeding the capsule bodies (1) and lids (2); a dosing station (6) for filling a dose of the material into each capsule body (1); and a station (7) for closing the capsules (C) by placing each lid (2) over the respective body (1) so that their respective annular ends (2a, 1a) overlap; the machine (4) being characterised in that between the dosing station (6) and the closing station (7) there is at least one intermediate operating station (8) for applying a sealing substance in the vicinity of the ends (1a, 2a).

2. The machine according to claim 1, characterised in that it comprises a handling turret (9) that causes the capsules (C) to follow a circular path (P) that brings them to the feed, dosing and closing stations (5, 6, 7), the sealing station (8) also being located on the circular path (P) of the turret (9).

3. The machine according to claim 2, characterised in that the sealing station (8) at least comprises retaining means (10) for keeping the capsule body (1) and the lid (2) separate from each other, the retaining means (10) being positioned radially on, and protruding from, the turret (9) and operating in conjunction with means (11) for handling at least the lids (2).

4. The machine according to claim 2, characterised in that the sealing station (8) at least comprises retaining means (10) for keeping the capsule body (1) and the lid (2) separate from each other, the retaining means (10) being positioned radially on, and protruding from, the turret (9); means (11) for handling at least the lids (2) and acting in conjunction with the retaining means (10); and means (12) for applying the sealing substance, facing the retaining means (10) and operating at the lids (2).

5. The machine according to claim 3, characterised in that the retaining means (10) comprise two separate parallel arms (13, 14) protruding radially from the turret (9); the arms (13, 14) having respective open-ended bushes (15, 16) forming retaining seats, the top one (15) for holding the lid (2), and the bottom one (16) for holding the body (1).

6. The machine according to claim 4, characterised in that the handling means (11) are located in the vicinity of the retaining means (10), move vertically in both directions and are equipped with means (17) for creating a vacuum which enables them to hold the lid (2) and to rotate the lid (2) while the sealing substance is being applied so that the sealing substance is spread uniformly along the circular inside area at the end (2a) of the lid (2).

7. The machine according to claim 4, characterised in that the means (12) for applying the sealing substance comprise at least one spray nozzle (18) for spraying the sealing substance on at least one lid (2).

8. The machine according to claim 7, characterised in that the nozzle (18) is mounted on a bracket (19) inclined by an angle (α) with respect to the longitudinal axis (Z) of the lid (2).

9. The machine according to claim 1, characterised in that the closing station (7) is equipped with means (7a) for handling the capsule lids (2) and bodies (1) in such a way as to fully close them by overlapping them at the ends (1a, 2a).

10. The machine according to claim 9, characterised in that the handling means (7a) comprise a pair of hollow, cylindrical pins (50, 51) located on the sides opposite the arms (13, 14) supporting the capsule body (1) and lid (2) and equipped with vacuum generating means (17); the second means (7a) being also equipped with vertical handling means (7b) which move the ends (1a, 2a) towards each other until they overlap and close.

11. The machine according to claim 10, characterised in that at least one of the pins (50, 51) is equipped with means (7c) for rotating it about its axis as the lid (2) and body (1) overlap, thus producing a twisting movement as the two parts are joined in such a way as to spread a sealing substance over the surfaces of the two ends (1a, 2a).

12. The machine according to claim 1, characterised in that downstream of the closing station (7) there is a station (20) for drying the sealed capsules (C) made.

13. The machine according to claim 12, characterised in that the drying station (20) also comprises a conveyor belt (21) for the capsules (C); the belt (21) having on its surface a plurality of seats (22) each designed to accommodate a single capsule (C) in such a way as to keep the capsules (C) in a stable position while the capsules (C) themselves are expelled.

14. The machine according to claim 1, characterised in that the sealing substance applied is an aqueous mixture of water and ethanol.

15. The machine according to claim 1, characterised in that the sealing substance applied is a cellulose based substance.

16. The machine according to claim 1, characterised in that the sealing substance applied is a gelatin based substance.

17. A method for producing sealed capsules (C), each defined by a body (1) coupled with a lid (2), the method at least comprising the steps of filling the capsule body (1) with a quantity or dose (3) of material and closing the capsule (C) by placing the lid (2) over the body (1) so that their respective annular ends (1a, 2a) overlap; the method being characterised in that it further comprises a step of applying a sealing substance to at least one of the overlapped ends (1a, 2a) of the capsule body (1) and lid (2), said sealing step being performed before the capsule (C) is closed.

18. The method according to claim 17, characterised in that the step of applying the sealing substance is performed at substantially the same time as the lid (2) partially overlaps the respective body (1).

19. The method according to claim 17, characterised in that the step of applying the sealing substance is performed while the capsule body (1) and lid (2) are held securely apart.

20. The method according to claim 17, characterised in that the step of applying the sealing substance is performed while rotating at least the lid (2) about its longitudinal axis (Z) in such a way as to apply the sealing substance to the annular end (2a) of the inside surface of the lid (2).

21. The method according to claim 17, characterised in that the step of applying the sealing substance is accomplished by spraying.

22. The method according to claim 17, characterised in that the sealing substance comprises an aqueous mixture comprising at least water and ethanol.

23. The method according to claim 17, characterised in that the sealing substance comprises a cellulose based liquid substance.

24. The method according to claim 17, characterised in that the sealing substance comprises a gelatin based liquid substance.

25. The method according to claim 17, characterised in that the step of closing the capsule (C) is followed by a step of drying the sealed capsule (C) while the latter is held in a stable position.
